(19) United States
(12) Patent Application Publication
(10) Pub. No.: US 2010/0129098 A1
(43) Pub. Date: May 27, 2010

(54) DEVELOPING METHOD AND DEVELOPING APPARATUS

(75) Inventor: Tadahisa AOKI, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY DISC & DIGITAL SOULTIONS INC., Tokyo (JP)

(21) Appl. No.: 12/567,183

(22) Filed: Sep. 25, 2009

(30) Foreign Application Priority Data
Nov. 21, 2008 (JP) 2008-298817

(51) Int. Cl. G03G 15/043; G03C 5/56

(52) U.S. Cl. 399/51; 430/434

(57) ABSTRACT

A developing method includes the steps of setting a resist substrate on a turntable, the resist substrate including a substrate, an inorganic resist layer formed on the substrate, and a latent image formed by exposure to light; discharging developer to a developer application position on an upper surface of the inorganic resist layer while rotating the turntable, the developer application position being away from the center of the resist substrate; irradiating a monitor position on the upper surface of the inorganic resist layer with laser light, the monitor position being different from the developer application position; and continuously discharging the developer, while detecting the amounts of zeroth order light and first order light reflected by the upper surface of the inorganic resist layer and monitoring the light amount ratio of the first order light to the zeroth order light, until the light amount ratio becomes a predetermined value.

### BACKGROUND OF THE INVENTION

1. Field of the Invention

The present invention relates to a developing method and a developing apparatus used for manufacturing a master optical disc.

2. Description of the Related Art

Regarding optical discs used for data storage media, various formats including CD and DVD have been proposed in accordance with their uses. An optical disc substrate used in each of the formats is generally made by injection molding a polymer material. On the surface of the substrate, a projection and depression pattern including pits and grooves is formed.

A projection and depression pattern including pits and grooves formed on an optical disc substrate represents data signals. By making the projection and depression pattern fine and dense, the capacity of an optical data storage medium can be increased.

A projection and depression pattern including pits and grooves is formed on an optical disc substrate by transferring a projection and depression pattern formed on a master optical disc to the optical disc substrate. The master optical disc having a projection and depression pattern thereon can be obtained by forming a resist layer on a substrate and then microfabricating the resist layer by lithography.

In recent years, high-density optical discs in Blu-ray Disc format (registered trademark, hereinafter referred to as “BD”), which have a storage capacity of about 25 G bytes in the case of single-sided single layer discs or about 50 G bytes in the case of single-sided dual layer discs, have become widespread. In order to provide a data capacity of 25 G bytes to a single sided optical disc having a diameter of 12 cm, it is necessary to decrease the minimum pit length to about 0.17 μm and the track pitch to about 0.32 μm. In order to form a fine projection and depression pattern on a master optical disc used for a high-density optical disc such as a BD, a method using an inorganic resist instead of an organic resist has been proposed (Japanese Unexamined Patent Application Publication No. 2003-315988).

When an inorganic resist material made of an incomplete oxide of transition metal is used as a resist layer, even if exposure to light is performed with visible laser light at a wavelength of about 405 nm, a pattern smaller than a spot diameter can be exposed due to a property of thermal recording. Therefore, the method of using an inorganic resist have received attention as a technique useful for mastering a master optical disc adapted to high-density recording.

The developing time of existing lithography using an organic resist is only about one minute. In contrast, the developing time of lithography using an inorganic resist is in the range of ten to thirty minutes because of a low reaction rate. Thus, a problem arises in that the size of pit openings of the projection and depression pattern varies due to the difference in developing time.

In order to address the problem, Japanese Unexamined Patent Application Publication No. 2006-344310 describes a developing method that involves lithography using an inorganic resist. The developing method is suitable for comparatively long time developing and allows precise control of developing.

The developing method described in Japanese Unexamined Patent Application Publication No. 2006-344310 includes a fixed time developing method, for which developing time is predetermined, and an additional developing method, which is additionally performed in accordance with the degree of progression of developing. Until developing progresses to a predetermined degree, developing is repeatedly performed.

With the developing method, a substrate having a resist layer formed thereon (hereinafter referred to as “resist substrate”) is developed for a predetermined period in a first developing step. Subsequently, in a monitoring step of monitoring the degree of developing, the degree of developing at a predetermined monitor position on the resist substrate is measured. In the monitoring step, laser light is incident on the resist substrate at the monitor position at a predetermined incident angle. The strengths of zeroth order light and first order light generated by a projection and depression pattern on the resist substrate are measured using a photosensor. As the photosensor, for example, a photodetector can be used. In the monitoring step, the degree of progression of developing can be detected from the light amount ratio of the first order light to the zeroth order light, since the strength of the first order light varies in accordance with the size of pit openings formed by developing.

Whether additional developing is necessary or not is determined from the measurement result of the light amount ratio obtained in the monitoring step. If necessary, additional developing is performed in a second developing step.

However, with a method including fixed time developing and additional developing that is performed as necessary, such as the method of Japanese Unexamined Patent Application Publication No. 2006-344310, it is difficult to perform developing stably and precisely because a large number of factors have to be optimized, such as the sensitivity of the inorganic resist, the power for cutting, the degradation of the developer, and the environment including temperature and humidity.

The monitoring step of Japanese Unexamined Patent Application Publication No. 2006-344310 is performed after the developer on the resist substrate has been removed in a rinsing step and a spin drying step. That is, the monitoring is performed after the developer has been removed from the surface of the resist substrate. Therefore, the degree of progression of developing may not be detected, and precise control of developing for manufacturing a high density master optical disc such as a BD may not be performed.

The monitor position for the monitoring step of Japanese Unexamined Patent Application Publication No. 2006-344310 is disposed in a recording signal area of the resist substrate at a predetermined distance from the center of the resist substrate or in a dedicated monitor signal section preformed outside the recording signal area. In order to perform monitoring, the developer on the monitor signal section has to be removed using nitrogen blow and a cutting step of cutting the monitor signal section, which is time-consuming, has to be separately performed, whereby productivity may be decreased. Moreover, since the degree of progression of developing at the monitor signal section is different from that of the signal area, precise developing may not be performed. Furthermore, it is necessary to prevent nitrogen blow from affecting developing of the signal area, because mist may be scattered due to nitrogen blow and a laser light source, photodetectors, and the like may be soiled.

### SUMMARY OF THE INVENTION

It is desirable to provide a developing method and a developing apparatus for a master optical disc that enables precise developing.

According to an embodiment of the present invention, there is provided a developing method including the steps of setting a resist substrate on a turntable that is rotatable, the resist substrate including a substrate, an inorganic resist layer formed on the substrate, and a latent image formed by exposing the inorganic resist layer to light; discharging developer to a developer application position on an upper surface of the inorganic resist layer while rotating the turntable, the developer application position being away from the center of the resist substrate; irradiating a monitor position on the upper surface of the inorganic resist layer with laser light, the monitor position being different from the developer application position; and continuously discharging the developer, while detecting the amounts of zeroth order light and first order light of the laser light reflected by the upper surface of the inorganic resist layer and monitoring the light amount ratio of the first order light to the zeroth order light, until the light amount ratio becomes a predetermined value.

In the developing method of the embodiment, the developer application position is away from the center of the resist substrate. Thus, when the developer is applied to the surface of the resist substrate, disturbance of the liquid surface of the developer at the monitor position, which is different from the developer application position, is reduced. Therefore, the amounts of the zeroth order light and the first order light of the laser light reflected at the monitor position are stably detected, whereby precision in detection is improved.

According to an embodiment of the present invention there is provided a developing apparatus including a turntable for rotating a resist substrate placed thereon, the resist substrate including a substrate, an inorganic resist layer formed on the substrate, and a latent image formed by exposing the inorganic resist layer to light; a nozzle for discharging developer to a developer application position of the resist substrate placed on the turntable, the developer application position being away from the center of the resist substrate; a laser light source for irradiating a monitor position on an upper surface of the inorganic resist layer of the resist substrate with laser light, the monitor position being different from the developer application position; a first sensor for detecting the amount of zeroth order light of the laser light reflected by the upper surface of the inorganic resist layer; and a second sensor for detecting the amount of first order light of the laser light reflected by the upper surface of the inorganic resist layer.

The developing apparatus of the embodiment includes the nozzle for discharging the developer in such a manner that the developer is applied to a position of the resist substrate that is away from the center of the resist substrate. Thus, the developer is discharged to the developer application position that is away from the center of the resist substrate, and the developer spreads from the developer application position so as to be applied to the entire surface of the resist substrate. Thus, at the monitor position, which is different from the developer application position, the flow rate of the developer is stable and disturbance of the liquid surface of the developer is reduced. Therefore, the amounts of the zeroth order light and the first order light of the laser light reflected at the monitor position are stably detected, whereby precision in detection is improved.

With an embodiment of the present invention, a resist substrate can be developed while stable detection data is being monitored, whereby control precision in developing is improved. Therefore, a fine projection and depression pattern can be formed.

### BRIEF DESCRIPTION OF THE DRAWINGS

FIGS. 1A to 1C are schematic views illustrating steps for manufacturing a master optical disc and an optical disc (part 1);

FIGS. 2D to 2F are schematic views illustrating steps for manufacturing a master optical disc and an optical disc (part 2);

FIGS. 3G to 3K are schematic views illustrating steps for manufacturing a master optical disc and an optical disc (part 3);

FIG. 4 is a schematic block diagram of an exposure apparatus that is used for manufacturing a master optical disc and an optical disc;

FIG. 5A is a schematic side view of a developing apparatus of a first embodiment of the present invention, and FIG. 5B is a schematic plan view of the developing apparatus;

FIG. 6 shows a monitoring result of detection obtained by the developing apparatus of the first embodiment;

FIG. 7A is a schematic side view of a developing apparatus of a comparative example, and FIG. 7B is a schematic plan view of the developing apparatus;

FIG. 8 shows a monitoring result of detection obtained by the developing apparatus of the comparative example; and

FIG. 9A is a schematic side view of a developing apparatus of a second embodiment of the present invention, and FIG. 9B is a schematic plan view of the developing apparatus.

### DESCRIPTION OF THE PREFERRED EMBODIMENTS

Hereinafter, embodiments of the present invention are described with reference to the drawings.

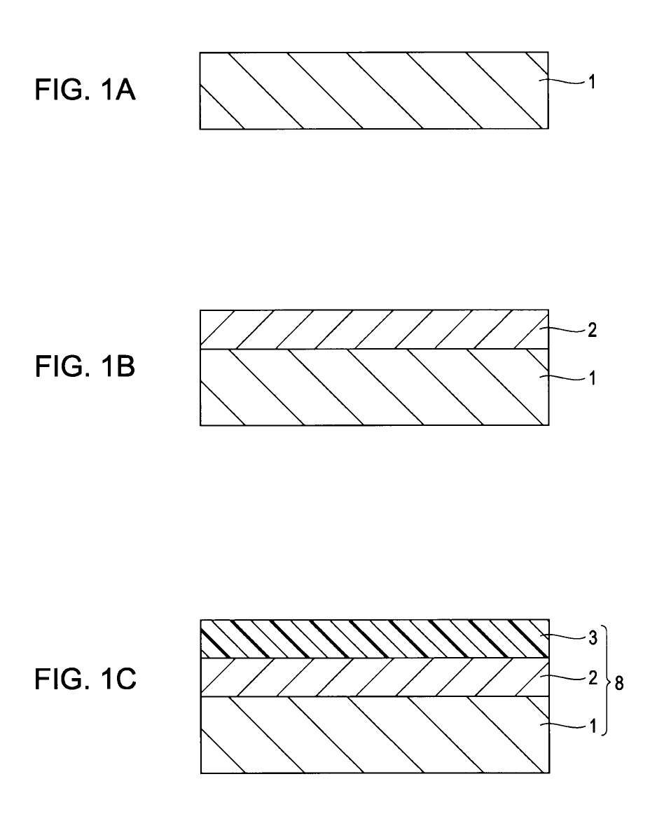

Referring to FIGS. 1A to 4, an example of a method of manufacturing a master optical disc and an optical disc is described in order to facilitate understanding of techniques related to the developing methods of the embodiments.

As shown in FIG. 1A, a substrate 1 having a flat surface is prepared. The substrate 1 is made of glass, silicon, plastic (polycarbonate), or the like. In the embodiments, the substrate 1 is made of silicon. By using a silicon substrate, front end steps including a rinsing step can be simplified as compared with the case using a glass substrate or a plastic substrate, so that the number of manufacturing steps can be decreased.

As shown in FIG. 1B, an intermediate layer 2 of amorphous silicon is formed on the substrate 1 by vapor deposition such as sputtering. Subsequently, as shown in FIG. 1C, an inorganic resist layer 3 is formed on the intermediate layer 2. The thickness of the inorganic resist layer 3 corresponds to the depth of pits and grooves on a master optical disc. The inorganic resist layer 3 is formed to have a thickness corresponding to a desired depth of pits and grooves.

The intermediate layer 2 is formed so as to provide a layer having a low thermal conductivity on the substrate 1, thereby optimizing the thermal storage effect.

The inorganic resist layer 3, which is formed in the step shown in FIG. 1C, is uniformly formed on the intermediate layer 2 by DC sputtering or RF sputtering. The inorganic resist layer 3 is made of an inorganic resist material. Examples of the inorganic resist material of the inorganic resist layer 3 include Ti, V, Cr, Mn, Fe, Nb, Cu, Ni, Co, Mo, Ta, W, Zr, Ru, and Ag. It is preferable that Mo, W, Cr, Fe, or Nb be used. In the embodiments, Mo and W are used as the inorganic resist material. Sputtering is performed by using argon (Ar) and oxygen (O₂) as sputtering gases. Thus, the inorganic resist layer 3 made of an incomplete oxide of W and Mo is formed.

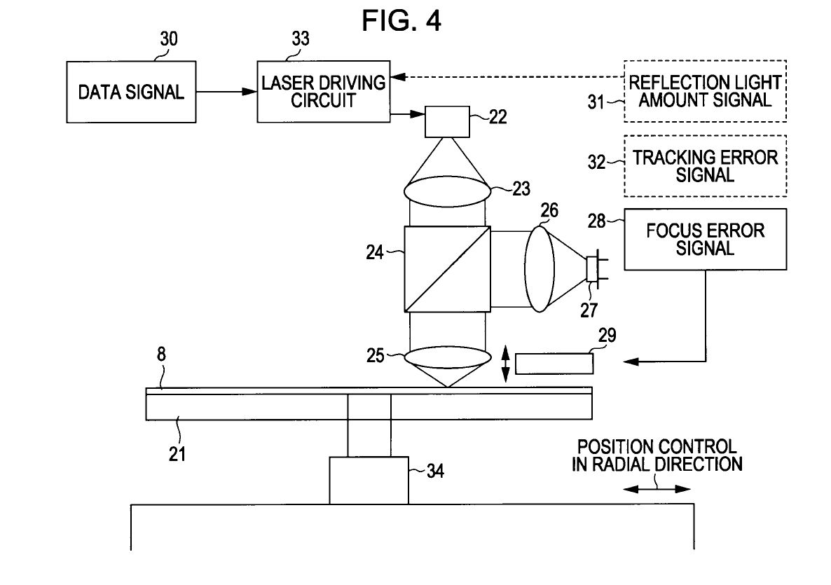

Next, the substrate 1 having the inorganic resist layer 3 formed thereon (hereinafter referred to as “resist substrate 8”) is set on a turntable of an exposure apparatus shown in FIG. 4 in such a manner that the inorganic resist layer 3 is on the upper side. FIG. 4 is a schematic block diagram of an example of an exposure apparatus that is used in the embodiment. The exposure apparatus includes a beam generator 22 that generates laser light for exposing the inorganic resist layer 3, a collimator lens 23 that parallelize the laser light emitted from the beam generator 22, a beam splitter 24, and an objective lens 25. Laser light emitted from the beam generator 22, which travels through the lenses, is focused on the inorganic resist layer 3 of the resist substrate 8, so that the inorganic resist layer 3 is irradiated with the laser light. The exposure apparatus is structured such that reflected light from the resist substrate 8 travels through the beam splitter 24 and a condenser 26 and the reflected light is focused on a divided photodetector 27. The divided photodetector 27 detects the reflected light from the resist substrate 8, generates a focus error signal 28 based on the detection result, and feeds the focus error signal 28 to a focus actuator 29. The focus actuator 29 controls the position of the objective lens 25 in the height direction.

A turntable 21 includes a feed mechanism, and the developing position of the resist substrate 8 can be precisely changed.

The exposure apparatus performs exposure or focusing while a laser driving circuit 33 controls the beam generator 22 on the basis of a data signal 30, a reflection light amount signal 31, and a tracking error signal 32. A spindle motor controller 34 is disposed on the center axis of the turntable 21. The spindle motor controller 34 control a spindle motor by setting an optimal number of revolutions on the basis of the position of an optical system in a radial direction and a desired linear velocity.

In the embodiments, the wavelength of laser light emitted from the beam generator 22 is determined in accordance with a desired line width to be exposed to light. When making a master optical disc for a BD, for example, it is preferable that laser light at a short wavelength be emitted. To be specific, it is preferable that the beam generator include a blue semiconductor laser that emits light at a wavelength of 405 nm.

The beam generator 22 is turned on and off in accordance with a recording signal. The term that the beam generator 22 is “turned off” means that the strength of laser light is made sufficiently low to such an extent that a pit is not thermally recorded on the inorganic resist layer 3.

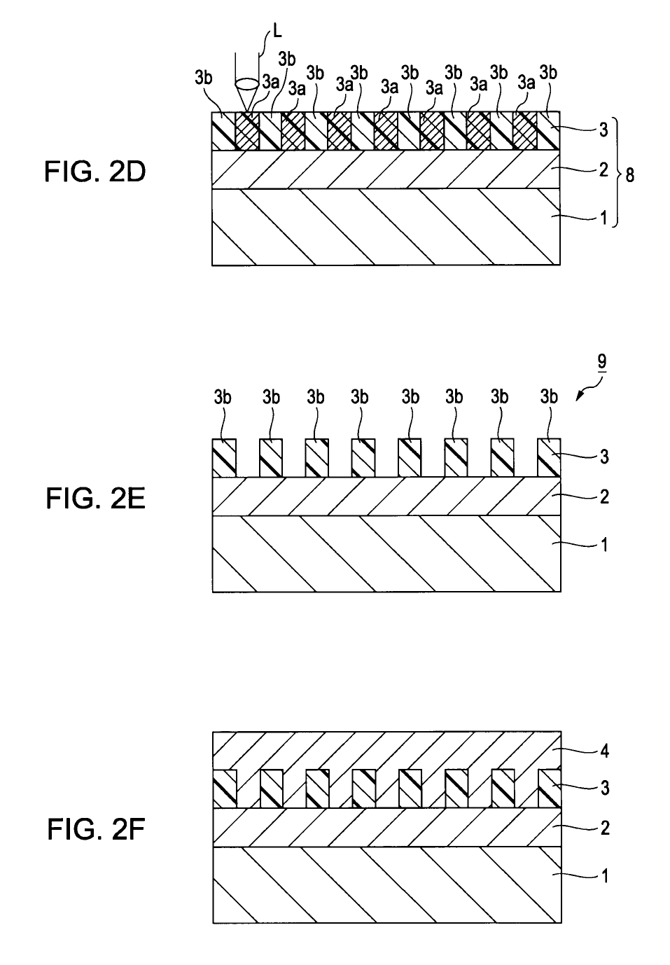

As shown in FIG. 2D, in the exposure step, desired positions of the inorganic resist layer 3 are irradiated with laser light L, so that exposed portions 3a and unexposed portions 3b are formed by thermochemical reaction and a latent image for forming pits and grooves on a master optical disc is formed.

After the exposure step, the resist substrate 8, on which a latent image corresponding to a desired projection and depression pattern has been formed, is developed by a wet process using alkali developer. In the developing step, a developing method of the embodiments described below is used. In the developing step, using a developing apparatus described below, the resist substrate 8 is set on a turntable that is rotatable, developer is applied to a desired position of the inorganic resist layer 3 while the resist substrate 8 is being rotated, and the exposed portions 3a of the inorganic resist layer 3 are etched.

As the alkali developer, organic alkali developer such as tetramethylammonium hydroxide solution, or inorganic alkali developer such as potassium hydroxide (KOH), sodium hydroxide (NaOH), or phosphoric acid based compound can be used.

After the developing step, the resist substrate 8 is sufficiently rinsed using pure water. After rinsing, the resist substrate 8 is rapidly spun so as to be dried.

With the above-described steps, making of a master optical disc 9 is completed.

As shown in FIG. 2F, a metallic film 4 is deposited on the projection and depression pattern on the upper surface of the master optical disc 9 by electroforming. As necessary, before performing electroforming, a mold release treatment may be applied to the upper surface of the inorganic resist layer 3 of the master optical disc 9 so as to improve releasablity.

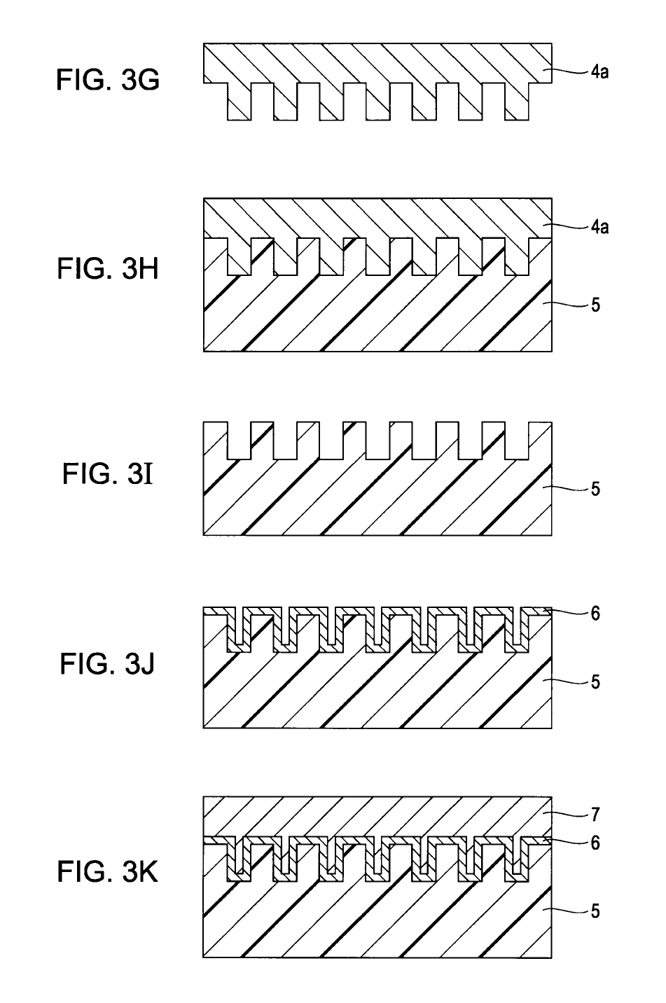

In the embodiments, a metallic nickel film is deposited on a projection and depression pattern on the upper surface of the master optical disc 9. After electroforming, the metallic film 4 that has been deposited is stripped from the master optical disc 9. As shown in FIG. 3G, a mold stamper 4a, to which the projection and depression pattern of the master optical disc 9 has been transferred, is obtained. After the mold stamper 4a is obtained, the master optical disc is rinsed with water, dried, and stored. As necessary, a desired number of the mold stampers 4a may be replicated repeatedly.

By using the mold stamper 4a stripped from the master optical disc 9 as a master, an electroforming step and a stripping step may be performed so as to make a mother master having a projection and depression pattern that is the same as that of the master optical disc. Moreover, by using the mother master as a new master, an electroforming step and a strip step may be performed so as to make a stamper having a projection and depression pattern that is the same as that of the mold stamper 4a.

As shown in FIG. 3H, using the mold stamper 4a, a disc substrate 5 made of polycarbonate, which is a thermoplastic resin, is formed by injection molding. Thus, the projection and depression pattern formed on the mold stamper 4a is transferred to the disc substrate 5. As shown in FIG. 3I, the mold stamper 4a is stripped from the disc substrate 5. As shown in FIG. 3J, a reflection film 6 made of an aluminum alloy is formed on the projection and depression pattern on the disc substrate 5. As shown in FIG. 3K, a protection film 7 is formed so as to cover the reflection film 6. Accordingly, making of an optical disc having a 12 cm diameter is completed.

By using a developing apparatus and a developing method described below in the above-described developing step of manufacturing a master optical disc and an optical disc, developing can be precisely performed while monitoring a resist substrate.

### First Embodiment

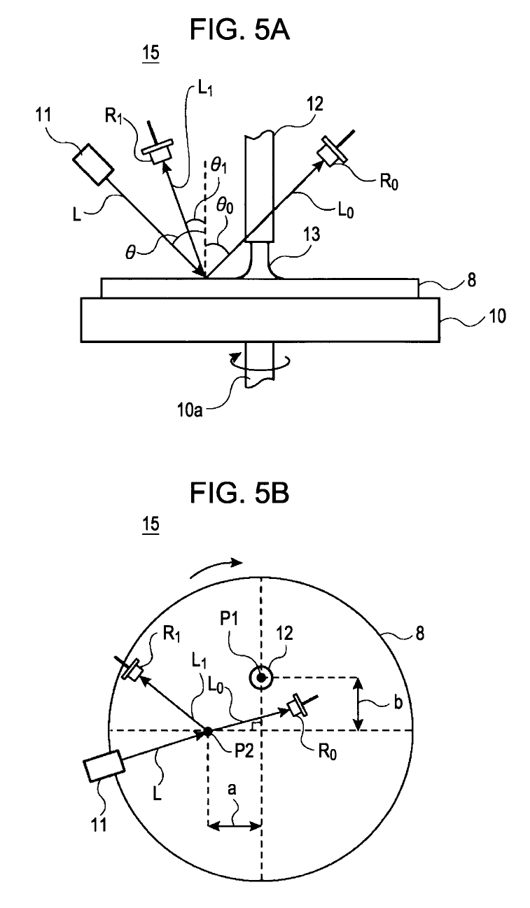

FIG. 5A is a schematic side view of a developing apparatus used in the developing step (shown in FIGS. 2D and 2E) of a first embodiment of the present invention. FIG. 5B is a schematic plan view of the developing apparatus. In the first embodiment, the resist substrate 8 to be developed has a latent image constituted by the exposed portions 3a with a track pitch of 0.32 μm for a BD.

As shown in FIGS. 5A and 5B, a developing apparatus 15 of the first embodiment includes a turntable 10 that is rotatable and a nozzle 12 for supplying developer 13. The developing apparatus 15 further includes a laser light source 11 for emitting laser light L for monitoring, a first sensor R₀ for detecting the amount of zeroth order light (reflected light) L₀ of the laser light L that has been reflected, and a second sensor R₁ for detecting the amount of first order light (diffracted light) L₁ of the laser light L that has been reflected.

The turntable 10 is attached to a rotation shaft 10a in such a manner that the turntable 10 can be moved up and down. The turntable 10 is rotated by the rotation shaft 10a. The resist substrate 8 is set on the turntable 10 using a vacuum chuck in such a manner that the inorganic resist layer 3 is on the upper side. As described above, the inorganic resist layer 3 formed on the substrate 1 has been exposed to light, and a latent image of a projection and depression pattern including pits and grooves is formed thereon. In the first embodiment, the turntable 10 is rotated such that the resist substrate 8 placed thereon is rotated at a number of revolutions in the range of 100 to 1000 rpm. In the example shown in FIG. 5, the turntable 10 is rotated clockwise.

The nozzle 12 supplies the developer 13 onto the surface of the inorganic resist layer 3 of the resist substrate 8 placed on the turntable 10. The nozzle 12 is disposed above a developer application position P1 that is away from the center of the resist substrate 8. That is, the nozzle 12 discharges the developer 13 to the developer application position P1 on the surface of the inorganic resist layer 3, which is away from the center of the resist substrate 8, and the entire surface of the resist substrate 8 is supplied with the developer. In the first embodiment, the nozzle 12 supplies the developer 13 at a flow rate in the range of 300 to 1000 ml/min.

It is preferable that the distance a between the developer application position P1 and the center of the resist substrate 8 be in the range of about 20 to 40 mm. If the distance between the developer application position P1 and the center of the resist substrate 8 is smaller than 20 mm, the flow rate of the developer 13 at a monitor position P2 (described below) becomes unstable, whereby monitoring at the monitor position P2 may not be performed precisely. If the distance between the developer application position P1 and the center of the resist substrate 8 is larger than 40 mm, developing at the central part of the resist substrate 8 becomes nonuniform. In the first embodiment, the distance a between the developer application position P1 and the center of the resist substrate 8 is about 30 mm.

The laser light source 11 emits the laser light L at a predetermined wavelength toward the monitor position P2 on the upper surface of the inorganic resist layer of the resist substrate 8 placed on the turntable 10. The laser light source 11 is disposed in such a manner that the upper surface of the inorganic resist layer of the resist substrate 8 can be irradiated with the laser light L at an incident angle θ relative to the normal of the upper surface and in a radial direction of the resist substrate 8.

The monitor position P2 is different from the developer application position P1 described above, and is a distance b from the center of the resist substrate 8. It is preferable that the monitor position P2 be in a middle part of the signal area of the resist substrate 8 in which a projection and depression pattern is formed. In the first embodiment, the distance b between the monitor position P2 and the center of the resist substrate 8 is about 40 mm.

The monitor position P2 is set at a position such that the resist substrate 8 rotates in a direction from the monitor position P2 toward the developer application position P1. That is, in the first embodiment, the turntable 10 rotates in a direction from the monitor position P2 on the resist substrate 8 toward the developer application position P1.

It is preferable that the developer application position P1 be deviated by an angle in the range of 60° to 120° from the monitor position P2 with respect to the center of the resist substrate 8. If this angle is smaller than 60°, the liquid surface of the developer at the monitor position may be disturbed by developer that is being applied. If the angle is larger than 120°, the flow rate of the developer becomes unstable, whereby monitoring at the monitor position P2 may not be performed precisely.

In the first embodiment, the developer application position P1 is deviated by an angle of about 90° from the monitor position P2 with respect to the center of the resist substrate 8 in the rotation direction of the turntable 10.

The first sensor R₀ measures the amount of the zeroth order light (reflected light) L₀, which is generated when the laser light L, with which the monitor position P2 on the upper surface of the inorganic resist layer of the resist substrate 8 is irradiated, is reflected at the monitor position P2.

The second sensor R₁ measures the amount of the first order light (diffracted light) L₁, which is generated when the laser light L, with which the monitor position P2 on the upper surface of the inorganic resist layer of the resist substrate 8 is irradiated, is reflected at the monitor position P2.

The positions at which the first sensor R₀ and the second sensor R₁ are disposed depend on the incident angle θ at which the monitor position P2 is irradiated with the laser light L emitted from the laser light source 11.

Table 1 shows a simulation result of the relationship among the wavelength λ of the laser light L emitted from the laser light source 11, incident angle θ at which the laser light L is incident on the surface of the inorganic resist layer 3, the reflection angle θ₀ of the zeroth order light L₀ of the laser light L reflected by the upper surface of the inorganic resist layer, and the diffraction angle θ₁ of the first order light L₁.

TABLE 1

| | | Track Pitch for BD | |
|---|---|---|---|
| Wavelength of | Incident Angle: θ = | | Diffraction Angle: |
| Laser Light L | Reflection Angle θ₀ | | θ₁ |
| λ (nm) | Zeroth Order Light | TP (μm) | First Order Light |
| 405 | 1 | 0.32 | — |
| 405 | 5 | 0.32 | — |
| 405 | 10 | 0.32 | — |
| 405 | 15 | 0.32 | — |
| 405 | 20 | 0.32 | 67.46 |
| 405 | 25 | 0.32 | 57.46 |
| 405 | 30 | 0.32 | 49.96 |
| 405 | 35 | 0.32 | 43.79 |
| 405 | 40 | 0.32 | 38.52 |
| 405 | 45 | 0.32 | 33.95 |
| 405 | 50 | 0.32 | 29.97 |
| 405 | 55 | 0.32 | 26.52 |
| 405 | 60 | 0.32 | 23.55 |
| 680 | 1 | 0.32 | — |
| 680 | 5 | 0.32 | — |
| 680 | 10 | 0.32 | — |
| 680 | 15 | 0.32 | — |
| 680 | 20 | 0.32 | — |
| 680 | 25 | 0.32 | — |
| 680 | 30 | 0.32 | — |
| 680 | 35 | 0.32 | — |
| 680 | 40 | 0.32 | — |
| 680 | 45 | 0.32 | — |
| 680 | 50 | 0.32 | — |
| 680 | 55 | 0.32 | — |
| 680 | 60 | 0.32 | — |

The simulation result shown in Table 1 is an example in which the resist substrate 8 for manufacturing a master optical disc for a BD is used. The resist substrate 8 includes the inorganic resist layer 3 on which a projection and depression pattern is formed with a pit length of 0.32 μm.

As shown in Table 1, when infrared rays at a wavelength of 680 nm are used as the laser light L, the first order light L₁ is not detected even if the incident angle θ is varied, because the projection and depression pattern for a BD is formed on the resist substrate 8 with a minute pit length.

When the upper surface of the inorganic resist layer is irradiated with blue laser light at a wavelength of 405 nm and the incident angle θ is in the range of 20° to 60°, the first order light L₁ can be detected. That is, for the resist substrate 8 on which a fine projection and depression pattern having a track pitch of 0.32 μm for a BD is formed, the first order light L₁ can be detected by using the laser light L at a wavelength of 405 nm. Although the laser light L at a wavelength of 405 nm is used in the simulation shown in Table 1, the first order light L₁ can be detected as long as the wavelength is in the range of 400 to 410 nm.

As shown in Table 1, the diffraction angle θ₁ of the first order light L₁ depends on the incident angle θ of the laser light L. The absolute value of the reflection angle θ₀ of the zeroth order light L₀ is about the same as the incident angle θ of the laser light L, since the zeroth order light L₀ is reflected light of the laser light L.

In the first embodiment, on the basis of the simulation result shown in Table 1, the laser light source 11 that emits the laser light L at a wavelength in the range of 400 to 410 nm is used. The first sensor R₀ and the second sensor R₁ are respectively disposed at positions at which the zeroth order light L₀ and the first order light L₁ of the laser light L corresponding to the incident angle θ can be detected.

The simulation result shown in Table 1 is a simulation result for the case when the resist substrate 8 is dry. In practice, however, the resist substrate 8 is irradiated with the laser light L when the developer 13 is applied to the resist substrate 8. Therefore, actual data for the diffraction angle θ₁ of the first order light L₁ has to be adjusted for a phase difference due to the developer 13.

Due to constraint of the developing apparatus 15, it is preferable that the incident angle θ and the reflection angle θ₀ of the laser light be equal to or smaller than 60°, or more preferably, equal to or smaller than 50°. It is preferable that the laser light source and the sensors be disposed such that, when the first sensor R₀ for detecting the amount of the zeroth order light L₀ and the second sensor R₁ for detecting the amount of the first order light L₁ are at nearest positions, the difference between the reflection angle θ₀ of the zeroth order light L₀ and the diffraction angle θ₁ of the first order light L₁ is equal to or larger than 20°.

In the first embodiment, the laser light source 11 is disposed above the resist substrate 8 such that the resist substrate 8 is irradiated with the laser light L emitted from the laser light source 11 at an incident angle θ of 46±2° at the monitor position P2. In this case, since the laser light L is reflected by the surface of the inorganic resist layer 3 of the resist substrate 8 at a reflection angle θ₀ of 46±2°, the first sensor R₀ for detecting the amount of the zeroth order light L₀ is disposed in a line such that the reflection angle θ₀ at the monitor position P2 is 46±2°.

The second sensor R₁ for detecting the amount of the first order light L₁, which is diffracted by the surface of the inorganic resist layer 3 of the resist substrate 8, is disposed in a line such that the diffraction angle θ₁ at the monitor position P2 is 33±2°. This diffraction angle θ₁ of the first order light corresponds to the laser light L at an incident angle θ₀ of 46±2° and is adjusted for the phase difference due to the developer 13.

In the developing apparatus 15, the resist substrate 8 is set on the turntable 10 that is rotatable and the turntable 10 is rotated. On the resist substrate 8, a latent image corresponding to a desired projection and depression pattern is formed by exposure to light. At the same time, the developer 13 is discharged toward the developer application position P1 on the surface of the inorganic resist layer 3 of the resist substrate 8. While the developer 13 is being discharged, the monitor position P2, which is different from the developer application position P1 of the resist substrate 8, is irradiated with the laser light L. The amounts I₀ and I₁ of the zeroth order light L₀ and the first order light L₁ reflected at the monitor position P2 are detected by the first sensor R₀ and the second sensor R₁, respectively. The amounts of light I₀ and I₁ represent the intensities of the zeroth order light L₀ and the first order light L₁, respectively.

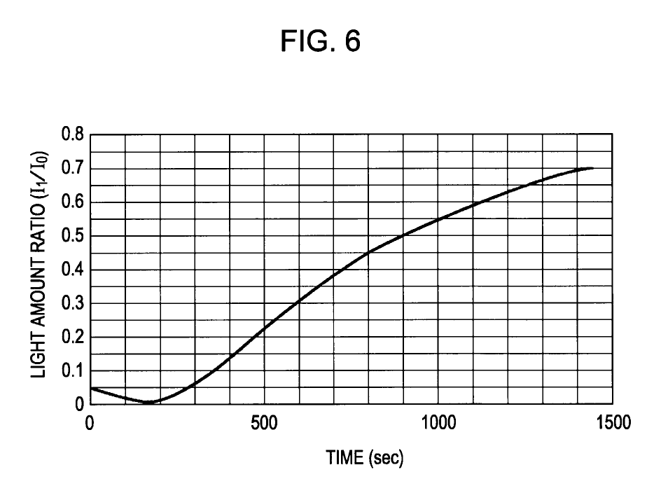

FIG. 6 shows variations in the light amount ratio I₁/I₀ of the first order light L₁ to the zeroth order light L₀ detected in the developing apparatus 15 of the first embodiment. In FIG. 6, the horizontal axis represents the developing time and the vertical axis represents the light amount ratio I₁/I₀.

In the first embodiment, the inorganic resist layer 3 is made of a positive resist, so that the exposed portions 3a, which are the portions on which latent images are formed by exposure to light, are dissolved by developing. Thus, as the developing progresses, the latent image is etched and the exposed portions 3a are pitted to have a desired projection and depression pattern, so that the first order light, which is diffracted light, is intensified. Thus, the light amount ratio I₁/I₀ of the first order light L₁ to the zeroth order light L₀ increases. In the first embodiment, developing is continued while monitoring the light amount ratio I₁/I₀. The developing finishes when the light amount ratio I₁/I₀ reaches a target value.

In the first embodiment, the developer application position P1 of the resist substrate 8 is away from the center of the resist substrate 8, and the monitor position P2 of the resist substrate 8 is different from the developer application position P1. Thus, the flow rate of the developer 13 at the monitor position P2 is stabilized, so that disturbance of the liquid surface can be suppressed. Therefore, fluctuations in the light amount ratio I₁/I₀ of the first order light L₁ to the zeroth order light L₀ caused by disturbance of the liquid surface can be reduced.

### COMPARATIVE EXAMPLE

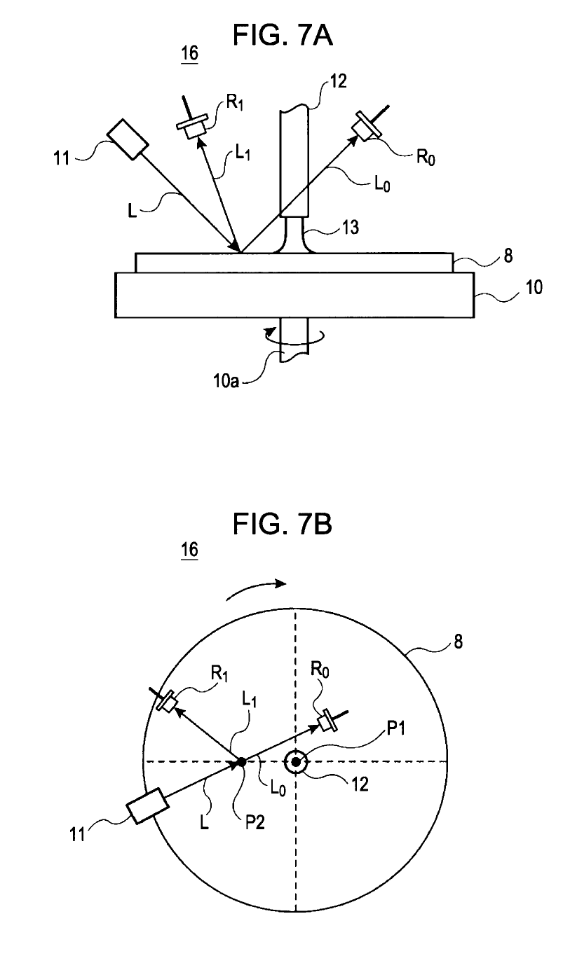

FIG. 7A is a schematic side view of a developing apparatus 16 of a comparative example, and FIG. 7B is a schematic plan view of the developing apparatus. In FIGS. 7A and 7B, the elements corresponding to those of FIGS. 5A and 5B are denoted by the same numerals and redundant descriptions are omitted.

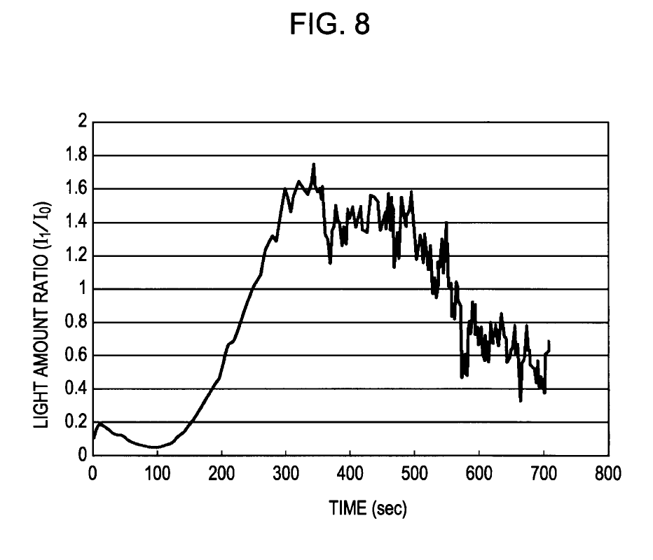

FIG. 8 shows variations in the light amount ratio I₁/I₀ of the first order light L₁ to the zeroth order light L₀ detected in the developing apparatus 16 of the comparative example. In FIG. 8, the horizontal axis represents a developing time and the vertical axis represents the light amount ratio I₁/I₀ of the first order light L₁ to the zeroth order light L₀.

As shown in FIGS. 7A and 7B, in the developing apparatus 16 of the comparative example, the nozzle 12 for supplying the developer 13 is disposed right above the center of the resist substrate 8, so that the developer application position P1 is at the center of the resist substrate 8. The comparative example is the same as the first embodiment except for the positions of the nozzle 12 and the developer application position P1.

As shown in FIG. 8, in the developing apparatus 16 of the comparative example, variations in the light amount ratio I₁/I₀ of the first order light L₁ to the zeroth order light L₀ with respect to the developing time are not stable, which implies that the monitoring precision is low. This is because, when the developer 13 is applied to the center of the resist substrate 8, the liquid surface of the developer 13 is disturbed at the monitor position P2, whereby detection of the light amount ratio I₁/I₀ is influenced by the disturbance of the liquid surface.

In contrast, in the developing apparatus 15 of the first embodiment, the developer application position P1 is away from the center of the resist substrate 8, whereby disturbance of the liquid surface at the monitor position P2 is reduced. Thus, the light amount ratio I₁/I₀ of the first order light L₁ to the zeroth order light L₀ detected in the first embodiment is stable with respect to the developing time as shown in FIG. 6, so that monitoring can be performed precisely. Therefore, in the first embodiment, the degree of progression of developing can be precisely monitored when a target value of the light amount ratio I₁/I₀ is set, whereby the size of pit openings in the exposed portions 3a etched by developing can be substantially precisely uniformized. Accordingly, the master optical disc 9 having a precisely formed projection and depression pattern can be obtained.

In existing developing methods, for example, developing time is fixed. Thus, a difference in the degree of progression of developing due to variations in the environment may not be detected. However, in the first embodiment, the difference in the degree of progression of developing can be controlled by monitoring the stable change of the light amount ratio I₁/I₀, whereby developing can be precisely controlled.

In the first embodiment, the developer application position P1 is away from the center of the resist substrate 8, whereby the light amount ratio can be detected without being influenced by disturbance of the liquid surface while the developer 13 is being applied. As a result, the degree of progression of developing can be detected without performing a drying step as in Japanese Unexamined Patent Application Publication No. 2006-344310. In the first embodiment, the monitor position P2 is disposed in the signal area, so that the signal area is directly monitored. Thus, it is not necessary to provide a dedicated monitor signal section to the outside of the signal area. This leads to improvement in productivity. Moreover, a step of performing nitrogen blow or the like, which may affect the degree of progression of developing, is not necessary. The laser light source 11 and the sensors are prevented from being soiled with mist due to the nitrogen blow.

The developing apparatus 15 and the developing method of the first embodiment are used in a developing step of manufacturing a high density master optical disc typified by a BD. However, embodiments of the present invention is not limited thereto.

Hereinafter, a developing apparatus and a developing method that can be used for developing steps of manufacturing master optical discs for a BD, a DVD, a CD, and the like are described.

### Second Embodiment

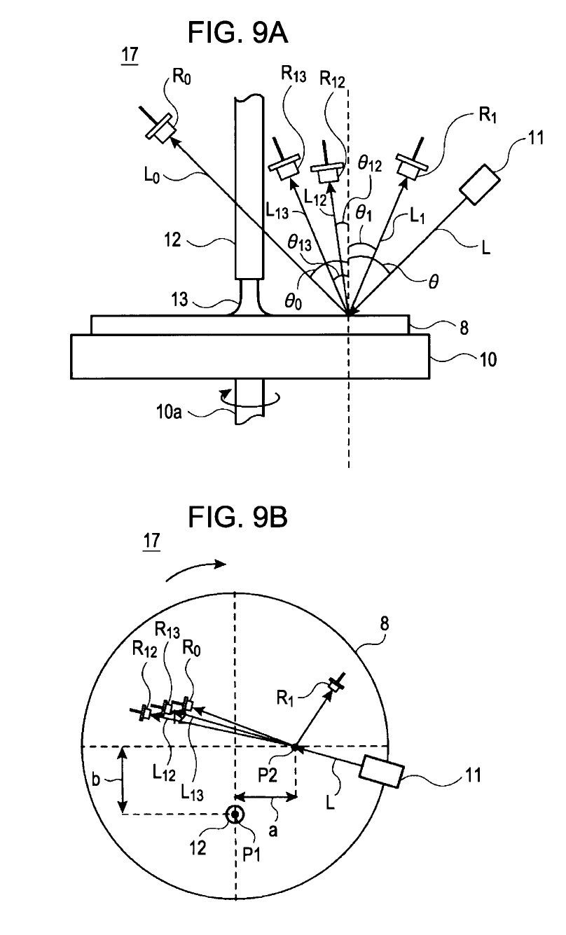

FIG. 9A is a schematic side view of a developing apparatus of a second embodiment of the present invention, and FIG. 9B is a schematic plan view of the developing apparatus.

A developing apparatus 17 of the second embodiment can be used in a developing step of manufacturing master optical discs for a BD, a DVD, and a CD. The track pitch for a BD is 0.32 μm, the track pitch for a DVD is 0.74 μm, and the track pitch for a CD is 1.60 μm. In FIGS. 9A and 9B, the elements corresponding to those in FIGS. 5A and 5B are denoted by the same numerals and redundant description is omitted.

As shown in FIG. 9B, in the second embodiment, the developer application position P1 is deviated by an angle of about 90° from the monitor position P2 with respect to the center of the resist substrate 8 in the rotation direction of the turntable 10. In the second embodiment, a plurality of second sensors R₁, R₁₂, and R₁₃ for detecting first order light L₁ reflected by the resist substrate 8 are provided. Since the track pitches of projection and depression patterns for a BD, a DVD, and a CD are different from each other, diffraction angles of the first order light of the laser light L reflected by the resist substrate 8 are different from each other. Therefore, in the second embodiment, the second sensors R₁, R₁₂, and R₁₃ corresponding to respective formats are provided.

The second sensor R₁ is used when developing the resist substrate 8 for a BD. The second sensor R₁ measures the amount of the first order light (diffracted light) L₁ that is generated when the laser light L is reflected at the monitor position P2 of the resist substrate 8 for a BD.

The second sensor R₁₂ is used when developing the resist substrate 8 for a DVD. The second sensor R₁₂ measures the amount of the first order light (diffracted light) L₁₂ that is generated when the laser light L is reflected at the monitor position P2 of the resist substrate 8 for a DVD.

The second sensor R₁₃ is used when developing the resist substrate 8 for a CD. The second sensor R₁₃ measures the amount of the first order light (diffracted light) L₁₃ that is generated when the laser light L is reflected at the monitor position P2 of the resist substrate 8 for a CD.

Table 2 shows a simulation result of the relationship among the wavelength λ of the laser light L emitted from the laser light source 11, the incident angle θ of the laser light L, the reflection angle θ₀ of zeroth order light L₀ of the laser light L reflected by the upper surface of the inorganic resist layer, and the diffraction angles θ₁, θ₁₂, and θ₁₃ of the first order light L₁, L₁₂, and L₁₃.

TABLE 2

| | Incident | | | Track Pitch | | | |
|---|---|---|---|---|---|---|---|
| | Angle: θ = | Track Pitch for BD | | for DVD | | Track Pitch for CD | |
| Wavelength | Reflection | | Diffraction | | Diffraction | | Diffraction |
| of | Angle θ₀ | | Angle: θ₁ | | Angle: θ₁₂ | | Angle: θ₁₃ |
| Laser Light L | Zeroth Order | | First Order | | First Order | | First Order |
| λ (nm) | Light | TP (μm) | Light | TP (μm) | Light | TP (μm) | Light |
| 405 | 1 | 0.32 | — | 0.74 | 31.99 | 1.60 | 13.63 |
| 405 | 5 | 0.32 | — | 0.74 | 27.40 | 1.60 | 9.55 |
| 405 | 10 | 0.32 | — | 0.74 | 21.94 | 1.60 | 4.56 |
| 405 | 15 | 0.32 | — | 0.74 | 16.77 | 1.60 | −0.33 |
| 405 | 20 | 0.32 | 67.46 | 0.74 | 11.85 | 1.60 | −5.10 |
| 405 | 25 | 0.32 | 57.46 | 0.74 | 7.16 | 1.60 | −9.76 |
| 405 | 30 | 0.32 | 49.96 | 0.74 | 2.71 | 1.60 | −14.29 |
| 405 | 35 | 0.32 | 43.79 | 0.74 | −1.51 | 1.60 | −18.69 |
| 405 | 40 | 0.32 | 38.52 | 0.74 | −5.48 | 1.60 | −22.93 |
| 405 | 45 | 0.32 | 33.95 | 0.74 | −9.20 | 1.60 | −27.00 |
| 405 | 50 | 0.32 | 29.97 | 0.74 | −12.64 | 1.60 | −30.86 |
| 405 | 55 | 0.32 | 26.52 | 0.74 | −15.77 | 1.60 | −34.47 |
| 405 | 60 | 0.32 | 23.55 | 0.74 | −18.59 | 1.60 | −37.80 |
| 680 | 1 | 0.32 | — | 0.74 | 64.35 | 1.60 | 24.05 |
| 680 | 5 | 0.32 | — | 0.74 | 56.28 | 1.60 | 19.75 |
| 680 | 10 | 0.32 | — | 0.74 | 48.18 | 1.60 | 14.56 |
| 680 | 15 | 0.32 | — | 0.74 | 41.31 | 1.60 | 9.57 |
| 680 | 20 | 0.32 | — | 0.74 | 35.23 | 1.60 | 4.76 |
| 680 | 25 | 0.32 | — | 0.74 | 29.76 | 1.60 | 0.14 |
| 680 | 30 | 0.32 | — | 0.74 | 24.77 | 1.60 | −4.30 |
| 680 | 35 | 0.32 | — | 0.74 | 20.20 | 1.60 | −8.54 |
| 680 | 40 | 0.32 | — | 0.74 | 16.03 | 1.60 | −12.58 |
| 680 | 45 | 0.32 | — | 0.74 | 12.23 | 1.60 | −16.39 |
| 680 | 50 | 0.32 | — | 0.74 | 8.79 | 1.60 | −19.94 |
| 680 | 55 | 0.32 | — | 0.74 | 5.73 | 1.60 | −23.21 |
| 680 | 60 | 0.32 | — | 0.74 | 3.03 | 1.60 | −26.17 |

The simulation result shown in Table 2 is an example in which the resist substrates 8 for manufacturing master optical discs for a BD, a DVD, and a CD are used. Each of the resist substrates 8 includes an inorganic resist layer on which a projection and depression pattern is formed with a predetermined pit length.

As shown in Table 2, when laser light at a wavelength of 680 nm is used, the first order light L₁₂ and L₁₃, which are diffracted light of the laser light, are detectable for the resist substrates for a DVD and a CD. However, the first order light L₁ diffracted by the resist substrate 8 for a BD is not detectable. As shown in Table 2, when the wavelength λ of the laser light L is 405 nm, the first order light L₁, L₁₂, L₁₃ diffracted by the resist substrates 8 for a BD, a DVD, and a CD are detectable when the incident angle θ of the laser light L is in the range of 20° to 60°.

Therefore, in the second embodiment, the laser light L at a wavelength in the range of 400 to 410 nm, which can be used for the resist substrates 8 for a BD, a DVD, and a CD, is used as the laser light L for monitoring. As in the case of Table 1, the simulation result shown in Table 2 is a simulation result for the case when the resist substrate 8 is dry. In practice, the data has to be adjusted for a phase difference due to the developer 13. The actual data for the diffraction angles θ₁, θ₁₂, and θ₁₃ of the first order light L₁, L₁₂, and L₁₃ are adjusted for the phase difference.

The second sensors R₁, R₁₂, and R₁₃ are disposed at positions such that, when the laser light L from the laser light source 11 is incident on the resist substrate 8 at an incident angle θ, diffracted light L₁, L₁₂, and L₁₃ having diffraction angles θ₁, θ₁₂, and θ₁₃ enter the second sensors R₁, R₁₂, and R₁₃, respectively. As with the first embodiment, the first sensor R₀ is disposed at a position such that, when the laser light L has the incident angle θ, the zeroth order light (reflected light) L₀ having a reflection angle θ₀ (=θ) enters the first sensor R₀.

In the cases when the diffraction angle θ₁, θ₁₂, and θ₁₃ in Table 2 are negative, the second sensors R₁, R₁₂, and R₁₃ are disposed on a side opposite the side of the laser light source 11 with respect to the broken line of FIG. 9A.

In the second embodiment, the laser light source 11 is disposed above the resist substrate 8 at a position such that the monitor position P2 of the resist substrate 8 is irradiated with the laser light L emitted from the laser light source 11 at an incident angle θ of 46±2°. In this case, the laser light L is reflected by the surface of the inorganic resist layer 3 of the resist substrate 8 at a reflection angle θ₀ of 46±2°. Therefore, the first sensor R₀ for detecting the amount of the zeroth order light L₀ is disposed in a line such that the reflection angle θ₀ from the monitor position P2 is 46±2°.

The second sensor R₁ for a BD for detecting the amount of the first order light L₁ of the laser light L diffracted by the surface of the inorganic resist layer 3 of the resist substrate 8 is disposed in a line such that the diffraction angle θ₁ from the monitor position P2 is 33±2°. The second sensor R₁₂ for a DVD for detecting the amount of the first order light L₁₂ of the laser light L diffracted by the surface of the inorganic resist layer 3 of the resist substrate 8 is disposed in a line such that the diffraction angle θ₁₂ from the monitor position P2 is 6±2°. The second sensor R₁₃ for a CD for detecting the amount of the first order light L₁₃ of the laser light L diffracted by the surface of the inorganic resist layer 3 of the resist substrate 8 is disposed in a line such that the diffraction angle θ₁₃ from the monitor position P2 is 27±2°.

The diffraction angles θ₁, θ₁₂, and θ₁₃ of the first order light L₁, L₁₂, and L₁₃ correspond to the case when the incident angle θ₀ of the laser light L is 46±2° and adjusted for a path difference due to the developer.

In the developing apparatus 17, the resist substrate 8 for a BD, a DVD, or a CD, on which a latent image is formed by exposure to light, is set on the turntable 10 that is rotatable, and the turntable 10 is rotated. In addition, the developer 13 is discharged toward the developer application position P1 on the upper surface of the inorganic resist layer. While the developer 13 is being discharged, the monitor position P2 on the upper surface of the inorganic resist layer, which is different from the developer application position P1 of the resist substrate 8, is irradiated with the laser light L. The amount of the zeroth order light L₀ of the laser light L reflected by the upper surface of the inorganic resist layer is detected by the first sensor R₀, and the amount of one of the first order light L₁, L₁₂, and L₁₃ is detected by a corresponding one of the second sensors R₁, R₁₂, and R₁₃.

As with the first embodiment, in the developing apparatus 17 of the second embodiment, the developer application position P1 is away from the center of the resist substrate 8, whereby disturbance of the liquid surface at the monitor position P2 is reduced. Thus, in the second embodiment, the light amount ratio I₁/I₀ of each of the first order light L₁, L₁₂, and L₁₃ to the zeroth order light L₀ can be stably detected, whereby precise monitoring can be performed. Therefore, in the second embodiment, the degree of progression of developing can be precisely monitored when a target value of the light amount ratio I₁/I₀ is set, whereby the size of pit openings of the exposed portion etched by developing can be substantially precisely uniformized. Accordingly, the master optical disc 9 having a precisely formed projection and depression pattern can be obtained.

Thus, with the second embodiment, advantages similar to those of the first embodiment can be obtained.

In the developing apparatus 17 of the second embodiment, short wavelength laser light L at a wavelength in the range of 400 to 410 nm is used as the laser light L for monitoring, so that the developing apparatus 17 can be used for developing step of making a BD, a DVD, and a CD.

Although three second sensors are used in the second embodiment, the number of the second sensors is not limited thereto. That is, the developing apparatus may be structured such that the developing apparatus can be used for developing the resist substrate 8 for a BD and a DVD. Alternatively, the developing apparatus may be structured such that the developing apparatus can be used for developing the resist substrate 8 for a DVD and a CD. In the second embodiment, the laser light L at a wavelength in the range of 400 to 410 nm is used for monitoring. However, in order to monitor a developing step of the resist substrate 8 for a DVD and a CD, the laser light at a wavelength of 680 nm can be used.

In the first and second embodiments, the developer application position P1 is deviated from the monitor position P2 in the rotation direction of the turntable 10 by an angle in the range of 60° to 120° with respect to the center of the resist substrate 8. In the first and second embodiments, the rotation direction of the turntable 10 is clockwise. However, even if the rotation direction is counterclockwise, the developer application position P1 may be deviated from the monitor position P2 in the rotation direction of the turntable 10 by an angle in the range of 60° to 120° with respect to the center of the resist substrate 8. By adjusting the positions of the sensors as appropriate, the advantages similar to those of the first and second embodiments can be obtained.

The present application contains subject matter related to that disclosed in Japanese Priority Patent Application JP 2008-298817 filed in the Japan Patent Office on Nov. 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A developing method comprising the steps of:
setting a resist substrate on a turntable that is rotatable, the resist substrate including a substrate, an inorganic resist layer formed on the substrate, and a latent image formed by exposing the inorganic resist layer to light;
discharging developer to a developer application position on an upper surface of the inorganic resist layer while rotating the turntable, the developer application position being away from the center of the resist substrate;
irradiating a monitor position on the upper surface of the inorganic resist layer with laser light, the monitor position being different from the developer application position; and
continuously discharging the developer, while detecting the amounts of zeroth order light and first order light of the laser light reflected by the upper surface of the inorganic resist layer and monitoring the light amount ratio of the first order light to the zeroth order light, until the light amount ratio becomes a predetermined value.

2. The developing method according to claim 1,
wherein the distance between the developer application position and the center of the resist substrate is in the range of 20 to 40 mm.

3. The developing method according to claim 1,
wherein the developer application position is deviated from the monitor position in a rotation direction of the resist substrate by an angle in the range of 60° to 120° with respect to the center of the resist substrate.

4. The developing method according to claim 2,
wherein the developer application position is deviated from the monitor position in a rotation direction of the resist substrate by an angle in the range of 60° to 120° with respect to the center of the resist substrate.

5. The developing method according to claim 1,
wherein the wavelength of the laser light is in the range of 400 to 410 nm.

6. A developing apparatus comprising:
a turntable for rotating a resist substrate placed thereon, the resist substrate including a substrate, an inorganic resist layer formed on the substrate, and a latent image formed by exposing the inorganic resist layer to light;
a nozzle for discharging developer to a developer application position of the resist substrate placed on the turntable, the developer application position being away from the center of the resist substrate;
a laser light source for irradiating a monitor position on an upper surface of the inorganic resist layer of the resist substrate with laser light, the monitor position being different from the developer application position;
a first sensor for detecting the amount of zeroth order light of the laser light reflected by the upper surface of the inorganic resist layer; and
a second sensor for detecting the amount of first order light of the laser light reflected by the upper surface of the inorganic resist layer.

7. The developing apparatus according to claim 6,
wherein the distance between the developer application position and the center of the resist substrate is in the range of 20 to 40 mm.

8. The developing apparatus according to claim 6,
wherein the developer application position is deviated from the monitor position in a rotation direction of the resist substrate by an angle in the range of 60° to 120° with respect to the center of the resist substrate.

9. The developing apparatus according to claim 7,
wherein the developer application position is deviated from the monitor position in a rotation direction of the resist substrate by an angle in the range of 60° to 120° with respect to the center of the resist substrate.

10. The developing apparatus according to claim 7,
wherein the wavelength of the laser light is in the range of 400 to 410 nm.

11. The developing apparatus according to claim 7,
wherein a plurality of the second sensors are disposed in positions different from one another.
